(19) United States
(12) Patent Application Publication
(10) Pub. No.: US 2026/0364870 A1
(43) Pub. Date: Nov. 19, 2026

(54) CONTAINER MOULDING UNIT WITH BOTTOM DETACHMENT SYSTEM

(71) Applicant: SIDEL PARTICIPATIONS, Octeville-sur-Mer (FR)

(72) Inventors: Arnaud BARBEY, OCTEVILLE- SUR-MER (FR); Yves BOURDEL, OCTEVILLE- SUR-MER (FR)

(21) Appl. No.: 19/135,540

(22) PCT Filed: Dec. 4, 2023
(86) PCT No.: PCT/EP2023/084102

§ 371 Date: Jun. 4, 2025

(30) Foreign Application Priority Data
Dec. 9, 2022 (FR) FR2213080
Aug. 4, 2023 (FR) FR2308505

(51) Int. Cl. B29C 49/48; B29L 31/00

(52) U.S. Cl. CPC B29C 49/4823; B29C 2049/4825; B29C 2049/4892; B29L 2031/7158

(57) ABSTRACT

Described is a moulding unit for producing a container from a plastics preform, including: a mould having a wall formed by two articulated half-moulds. internal At a lower end, the mould has a a mould bottom which fits into a lower opening and has an upper surface defining an at least partial impression for the bottom of the container. The mould bottom has a centre opening through which an actuator can slide. The mould bottom is mounted on a saddle defining a housing in which the piston of the actuator is mounted. The mould bottom and/or an insert comprises pneumatic means to detach the wall from the bottom of the blown container, while simultaneously providing cooling of said bottom of the blown container.

### TECHNICAL FIELD

The present invention relates to producing containers, such as bottles, which are produced by stretch-blow-molding from preforms made of plastics material (primarily thermoplastic, for example PET or recycled PET, so-called rPET).

### PRIOR ART

In the field of packaging, it is well known that a container comprises a wall part (generally of cylindrical shape), a neck which is open at an upper end of the wall part and a bottom which is closed at a lower end of the wall part.

The production of a container by blowing generally comprises the insertion of a preform, also commonly called a blank, into a molding unit having a mold side wall defining a counter-impression of the wall part of the container and a mold bottom defining a counter-impression of the bottom of the container, said preform having been previously heated to a temperature greater than the glass transition temperature of the material, and the injection of a pressurized fluid (such as air) inside the hot preform. The blowing can be (and is generally) completed by stretching the preform by means of a sliding rod called a stretching rod which is introduced into the preform.

Thus blow-molding, while being stretched in the longitudinal direction by a coaxially provided stretching rod, is well known.

Moreover, as the quantity of material required for the production of each container is continually decreasing over the years for economic and environmental reasons, it is necessary to improve the structural rigidity of the container.

The improvement of the structural rigidity of the wall portion is implemented in the known manner by a series of annular grooves forming stiffeners, the function thereof being to minimize the risk of the ovalization of the container (i.e. the deformation of the cross section of the container from a circular shape to an oval shape).

Several techniques are also known for providing the structural rigidity of the bottom of the container. One technique consists in providing the bottom of the container with stiffening objects such as ribs, the function thereof being to minimize the risk of the bottom collapsing under bending stresses, due to the hydrostatic pressure of the contents and potentially the weight of the containers stacked on the same pallet.

A further technique consists in providing an additional stretching of the material of the bottom of the container in order to increase its crystallinity mechanically (and thus its mechanical rigidity). As indicated in the published PCT application WO 99/52701, this is generally carried out by means of a mobile mold bottom which is slidably mounted relative to the side wall of the mold, so that the material of the container is firstly blown beyond the final shape in a retracted position of the mold bottom, then stamped to the final shape by the displacement of the mold bottom to a raised position in which it completes, with the side wall of the mold, the counter-impression of the container. The molding unit comprises a cylindrical shell and at least one part of the mold bottom has a cylindrical support which is slidably received in the cylindrical shell.

The mold bottom is generally displaced by means of a linear actuator, such as a hydraulic or pneumatic actuator, comprising a cylindrical casing and a rod which is slidably mounted inside the casing and to which the liner of the cylinder of the mold bottom is fixed.

However, the external surface of the embossed bottom of the container, thus blown into the mold, adheres to the lower internal surface of the mold bottom so that it is difficult to remove the container without the bottom of the container turning, making the container unusable.

### DISCLOSURE OF THE INVENTION

One of the objects of the invention is thus to remedy these drawbacks by proposing, relative to these drawbacks, a molding unit which is of simple and inexpensive design and which enables a removal of the molded container without the bottom of the container turning, while said bottom of the container is being cooled and while a mechanical part is also being cooled, without having to resort to an internal circulation of fluid.

To this end, and according to the invention, a molding unit is proposed for producing a container from a plastics preform, this molding unit having at least: a mold comprising a wall formed by two articulated half-molds defining an internal cavity distributed about a main axis of the mold and defining at least partially an impression for a side wall or body and having, at a lower end, a lower opening, a mold bottom which fits into the lower opening and has an upper surface defining an at least partial impression for the bottom of the container, the mold bottom being penetrated at its center by an opening, an actuator comprising a piston and a rod at the end of which is mounted an insert capable of sliding through said opening of the mold bottom, between a so-called deployed position, in which a free end of the insert protrudes with respect to the mold bottom, and a so-called retracted position, in which the free end of the insert is situated in the vicinity of the mold bottom, and a saddle on which the mold bottom is mounted, said saddle comprising at least a lower stage and an upper stage mounted on the lower stage, said saddle internally defining a housing in which the piston of the actuator is mounted; said molding unit being characterized in that the mold bottom and/or the insert comprises pneumatic means of detachment of the wall from the bottom of the blown container, said pneumatic detachment means simultaneously providing cooling of said bottom of the blown container.

Advantageously, said insert comprises a so-called central recess which is connected to a source of fluid at a specific pressure and, at its upper end, at least one orifice opening into said central recess.

Preferably, said insert comprises on its side wall, in the vicinity of its upper end, a plurality of orifices opening into said central recess.

Moreover, the axis of said orifices preferably forms an angle of between 30 and 80° with the longitudinal axis of the insert.

Advantageously, said mold bottom comprises a plurality of channels opening into the upper face of said mold bottom, forming orifices, said channels being fluidically connected to a pressurized source of fluid.

Moreover, said mold bottom comprises a plurality of channels opening at a first end into the upper face of the mold bottom, forming orifices, and opening at the opposing end into the central channel of the opening of the mold bottom in which the insert slides.

In addition, the central channel of the mold bottom comprises a seal, at least above the channels opening into said central channel.

Moreover, the axis of said channels of the mold bottom forms an angle of between 20 and 80° with the longitudinal axis of the insert.

Preferably, the channels of the mold bottom opening into the central channel extend perpendicularly to the orifices of the insert when said insert is in its retracted position.

Moreover, the orifices of the insert are angularly distributed about the side wall of said insert.

Moreover, the channels of the mold bottom are also angularly distributed about the central axis of said mold bottom.

Advantageously, said molding unit comprises means for activating the circulation of the pressurized fluid in the mold bottom and/or in the insert in the production cycle of the containers, capable of controlling the start of said activation and the period of activation so as to promote the detachment of the wall from the bottom of the blown container and/or cooling the insert and/or the mold bottom.

### BRIEF DESCRIPTION OF THE DRAWINGS

Further advantages and features will emerge more clearly from the following description of several variants, provided by way of non-limiting examples, of the molding unit according to the invention, with reference to the accompanying drawings, in which:

FIG. 1 is a perspective view of the molding unit according to the invention,

FIG. 2 is a radial sectional view of the molding unit according to the invention shown in FIG. 1,

FIG. 3 is a radial sectional perspective view of the saddle of the molding unit according to the invention,

FIG. 4 is a radial sectional view of the saddle of the molding unit according to the invention,

FIG. 5 is a perspective view from above of the mold bottom and the insert of the molding unit according to the invention,

FIG. 6 is a radial sectional view of the saddle of the molding unit according to the invention, with the insert in the retracted position,

FIG. 7 is a radial sectional view of the saddle of the molding unit according to the invention, with the insert in the deployed position.

### EMBODIMENT OF THE INVENTION

The same reference numerals denote the same elements in the remainder of the description of the molding unit according to the invention. The different views are not necessarily drawn to scale.

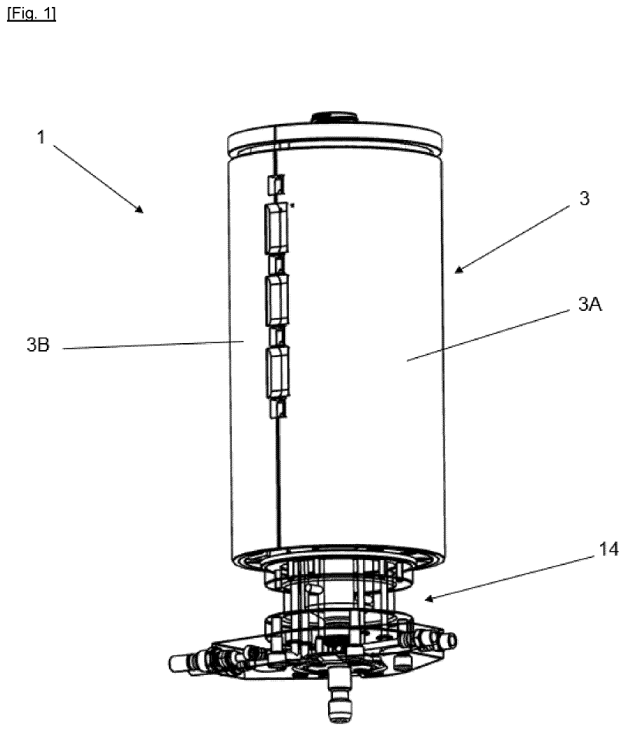

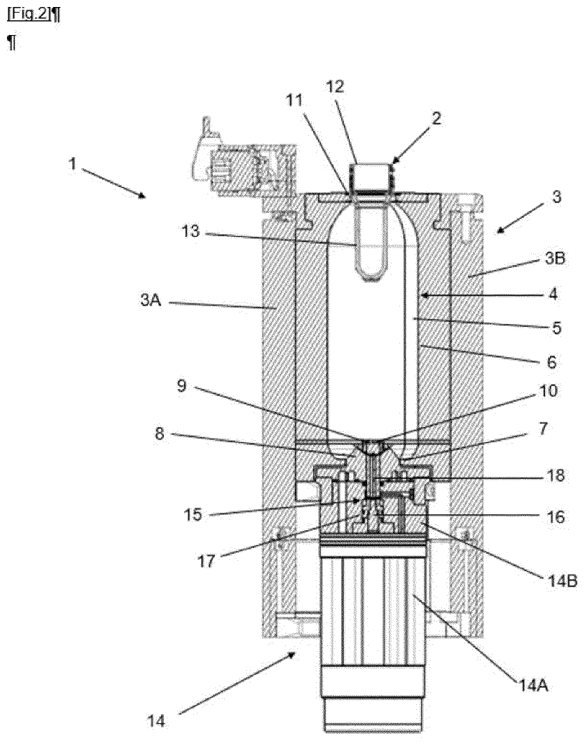

A molding unit 1 for producing a container by blowing (or by stretch-blowing) from a blank 2 made of plastics material is shown in FIGS. 1 and 2. In the illustrated example, the blank 2 is a preform but it could be an intermediate container obtained from a preform which has been subjected to one or more preliminary molding operations. According to a preferred embodiment, the material in which the blank is produced is PET and/or rPET (recycled PET).

Said molding unit 1 firstly comprises a mold 3. This mold 3 comprises a wall 4 formed by two articulated half-molds 3A, 3B defining an internal cavity 5 distributed about a main axis of the mold 3, which forms an axis of symmetry of the mold 3 when the containers to be molded are symmetrical in revolution.

The cavity 5 defines at least partially an impression 6 for a side wall or body of the container. The wall 4 has an opening 7 defining a passage for a mold bottom 8, provided with a central opening 9 and comprising an insert 10 which is movably mounted relative to the mold bottom 8 between a retracted position in which the insert 10 is separated from the opening 9 (and thus is retracted relative to the cavity 5) and a deployed position in which the insert 10 protrudes at least partially from the mold bottom 8 into the cavity 5.

Said mold bottom 8 has a molding surface 9 defining an impression for the relevant part of the container 2. In the deployed position, the insert 10 protrudes from the mold bottom 8, thus completing the impression of the container against which the material is applied during the blowing process. The distance separating the retracted position from the deployed position is called the “travel” of the insert 10. For the purposes of clarity, the mold 3 has been shown in a configuration where the travel of the insert 10 is relatively large relative to the height of the container. This configuration is not limiting in any way; on the contrary, the travel of the insert 10 can be small relative to the height of the container without otherwise departing from the scope of the invention.

Moreover, said mold bottom 8 can be movably mounted relative to the wall 4 between a retracted position in which the mold bottom 8 is separated from the opening 7 (and thus is retracted relative to the cavity 5) and a deployed position in which the mold bottom 8 protrudes at least partially into the cavity 5.

As illustrated in FIG. 2, the blank 2, then the container molded therefrom, rest on an upper face of the mold 3 by means of a flange 11 of the blank 2 (respectively of the container) which delimits a neck 12 of the blank 2 (respectively of the container) held outside the mold 3. Below the flange 11, the blank 2 (then the container) has a body 13 which generally extends in the axial direction, and a bottom which is initially hemispherical and then, once molded against the mold bottom 8, generally extends in the radial direction from a lower end of the body 13.

In order to mold the container, the blank 2 is introduced into the mold 3 and a pressurized fluid (preferably a gas, for example air) is injected. In the conventional manner, the molding can comprise at least two phases, namely: a pre-blowing phase, during which a fluid at a so-called pre-blowing pressure (the pre-blowing pressure usually being less than or equal to 15 bar and for example in the order of 7 to 12 bar) is injected into the blank 2, and a blowing phase during which a fluid at a so-called blowing pressure (the blowing pressure being greater than or equal to 15 bar and for example in the order of 30 to 40 bar) is injected into the blank 2.

Moreover, the molding unit 1 also comprises a stretching rod, not shown in the figures, capable of extending inside the blank 2, coaxially to the longitudinal axis of said blank 2, and of being displaced along said longitudinal axis in order to stretch said blank 2 during the pre-blowing step, in particular in a manner well known per se.

The molding unit 1 secondly comprises a boxing system called a saddle 14. The term “boxing” is used here to denote an operation of pushing back the material of the container during the molding operation. This saddle 14 firstly comprises an actuator 15 for controlling the position of the insert 10 of the mold bottom 8 which is fixed to the upper end of said saddle 14.

Said actuator 15 comprises a piston 16 extending in a housing 17 produced in the saddle 14 and a rod 18 bearing said insert 10 at its upper end. The piston 16 and the rod 18 are integrally movable relative to the actuator body, formed by the housing 17 produced in the saddle, between a retracted position corresponding to the retracted position of the insert 10 of the mold bottom 8 and a deployed position corresponding to the deployed position of said insert 10 of the mold bottom 8.

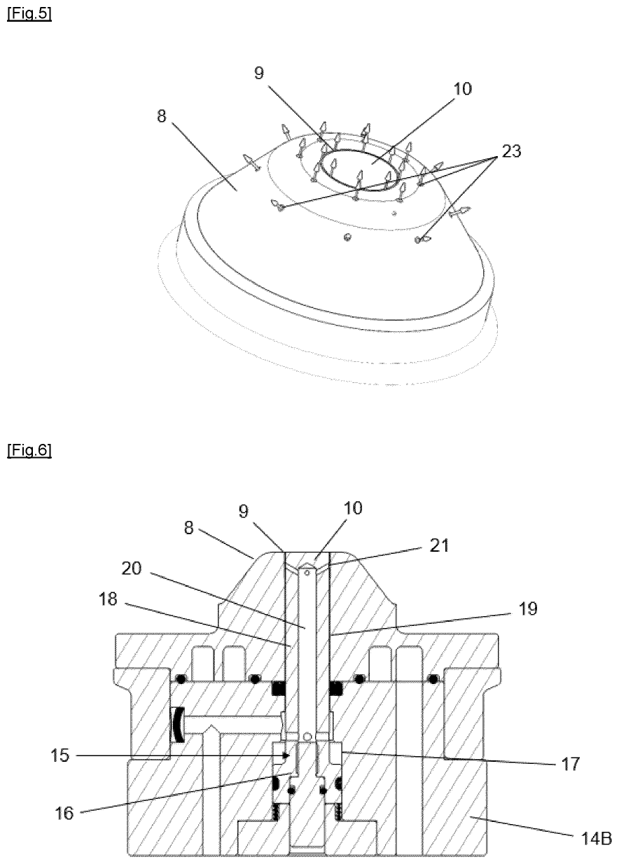

With reference to FIGS. 2 to 5, the insert 10 extends through the mold bottom 8 into the opening 9 coaxially to the stretching rod, said insert 10 being capable of being displaced from a so-called retracted position, in which the upper end of the insert 10 extends inside the opening 9 which forms a central vertical channel 19 in the saddle 14, to a so-called active position in which said insert 10 protrudes from said mold bottom 8.

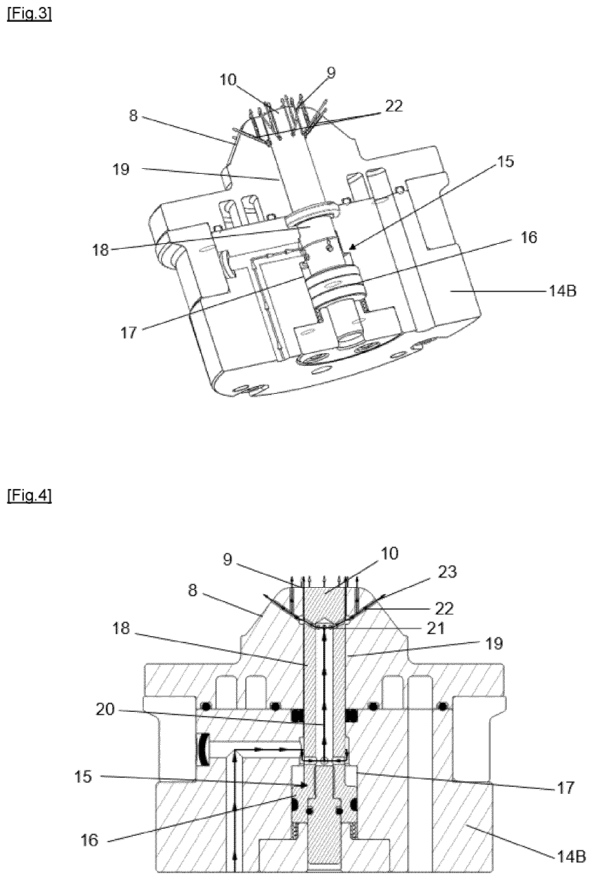

According to an essential feature, with reference to FIGS. 3 and 4, said insert 10 comprises pneumatic means of detachment of the wall from the bottom of the blown container. More specifically, said insert 10 comprises a so-called central recess 20 which is connected to a source of fluid (not shown in the figures) at a specific pressure and, at its upper end, at least one orifice 21 opening into said central recess 20. In this particular exemplary embodiment, said insert 10 comprises on its side wall, in the vicinity of its upper end, a plurality of orifices 21 opening into said central recess 20. The axis of said orifices 21 forms an angle of between 30 and 80°, and preferably an angle of between 30 and 50°, with the longitudinal axis of said insert 10.

It will be observed that it is possible for said so-called central recess 20 not to be perfectly centered. In other words, it is possible for the axis of the central recess 20 not to be coaxial with the axis of the insert 10. Moreover, the straight cross section of said central recess 20 is preferably circular; however it is obvious that the straight cross section of the central recess 20 could have any shape without departing from the scope of the invention.

Moreover, said mold bottom 8 also advantageously comprises a plurality of channels 22 opening into the upper face of the mold bottom 8, forming orifices 23, said channels 22 being fluidically connected to a pressurized source of fluid. More specifically, said mold bottom 8 comprises a plurality of channels 22 opening at a first end into the upper face of the mold bottom 8, forming orifices 23, and opening at the opposing end into the central channel 19 of said mold bottom 8 through which the insert 10 extends. The axis of said channels 22 forms an angle of between 20 and 80° with the longitudinal axis of the insert 10. Said channels 22 of the mold bottom 8 opening into the central recess 19 extend perpendicularly to the orifices 21 of the insert 10 when said insert 10 is in its retracted position. Thus, when the insert 10 is in its retracted position, the orifices 21 of the insert 10 extend perpendicularly to the channels 22 of the mold bottom 8 in order to supply them with pressurized fluid and to detach the bottom of the container relative to the mold bottom 8.

In this particular exemplary embodiment, the central channel 19 of the mold bottom 8 does not comprise a seal so that the air also escapes in the region of the opening 9 of the mold bottom 8 between the insert 10 and the edge of the opening 9 of said mold bottom 8.

According to a variant, the central channel 19 of the mold bottom 8 could comprise a seal, at least above the channels 22 opening into said central channel 19.

Moreover, and preferably, the orifices 23 of the insert 10 are angularly distributed about the side wall of said insert 10 and the channels 22 of the mold bottom 8 are angularly distributed about the central axis of said mold bottom 8.

It will be observed that, depending on the moment of activation of the circulation of pressurized fluid in the insert 10 and/or the mold bottom 8 in the cycle, and the activation period, said activation means being included in a control unit, not shown in the figures, the invention advantageously makes it possible to promote the detachment of the wall from the bottom of the blown container and/or to cool the mold bottom 8 which is without any internal cooling source, such as a circulation of fluid, due to its integration and its mobility.

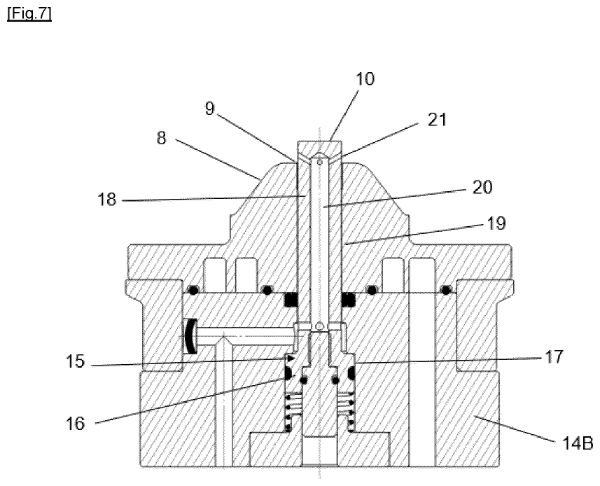

According to a variant, with reference to FIGS. 6 and 7, the insert 10 extends in the same manner as above through the mold bottom 8 into the opening 9 coaxially to the stretching rod, said insert 10 being capable of being displaced from a so-called retracted position in which the upper end of the insert 10 extends inside the opening 9 which forms a vertical channel 19 in the saddle 14 to a so-called active position in which said insert 10 protrudes from said mold bottom 8.

Moreover, in the same manner as above, said insert 10 comprises pneumatic means of detachment of the wall from the bottom of the blown container. More specifically, said insert 10 comprises a central recess 20 which is connected to a source of fluid (not shown in the figures) at a specific pressure and, at its upper end, at least one orifice 21 opening into said central recess 20. In this particular exemplary embodiment, said insert 10 comprises on its side wall, in the vicinity of its upper end, a plurality of orifices 21 opening into said central recess 20. The axis of said orifices 21 forms an angle of between 30 and 80°, and preferably an angle of between 30 and 50°, with the longitudinal axis of said insert 10.

Thus this variant is differentiated from that described above by the fact that the mold bottom 8 does not comprise channels 22 opening into the central channel 19.

Finally, it goes without saying that the examples which have been provided are only specific illustrations and are in no way limiting relative to the fields of application of the invention.

1. A molding unit for producing a container from a plastics preform, the molding unit comprising:
a mold comprising a wall formed by two articulated half-molds defining an internal cavity distributed about a main axis of the mold and defining at least partially an impression for a side wall or body,
the mold comprising at a lower end, a lower opening and a mold bottom which fits into the lower opening, wherein the mold bottom and has an upper surface defining an at least partial impression for the bottom of the container, the mold bottom comprising a center opening;
an actuator comprising a piston and a rod, an end of the rod comprising an insert configured to slide through said opening of the mold bottom, between a deployed position, in which a free end of the insert protrudes with respect to the mold bottom, and a retracted position, in which the free end of the insert is situated in a vicinity of the mold bottom; and
a saddle on which the mold bottom is mounted, said saddle comprising at least a lower stage and an upper stage mounted on the lower stage, said saddle internally defining a housing in which the piston of the actuator is mounted, wherein the mold bottom and/or the insert comprises pneumatic means of detachment of the wall from the bottom of the blown container, said pneumatic detachment means simultaneously providing cooling of said bottom of the blown container.

2. The molding unit as claimed in claim 1, wherein said insert comprises a central recess which is connected to a source of fluid at a specific pressure and at least one orifice at an upper end of the insert opening into said central recess.

3. The molding unit as claimed in claim 2, wherein said insert comprises, a plurality of orifices opening into said central recess, the plurality of orifices being located on a side wall near the upper end of the insert.

4. The molding unit as claimed in claim 3, wherein an axis of said orifices forms an angle of between 30 and 80° with a longitudinal axis of the insert.

5. The molding unit as claimed in claim 1, wherein said mold bottom comprises a plurality of channels opening into an upper face of said mold bottom, forming orifices, said channels being fluidically connected to a pressurized source of fluid.

6. The molding unit as claimed in claim 5, wherein said mold bottom comprises the plurality of channels open at a first end into the upper face of the mold bottom, and open at an opposing end into the central opening of the mold bottom.

7. The molding unit as claimed in claim 6, wherein the central opening of the mold bottom comprises a seal, at least above the channels opening into said central opening.

8. The molding unit as claimed in claim 5, wherein the axis of said plurality of channels forms an angle of between 20 and 80° with a longitudinal axis of the insert.

9. The molding unit as claimed in claim 6, wherein the channels of the mold bottom opening into the central opening extend perpendicularly to the orifices of the insert when said insert is in its retracted position.

10. The molding unit as claimed in claim 3, wherein the orifices of the insert are angularly distributed about the side wall of said insert.

11. The molding unit as claimed in any one of claim 5, wherein the channels of the insert are angularly distributed about a central axis of said insert.

12. The molding unit as claimed in claim 1, comprising means for activating circulation of the pressurized fluid in the mold bottom and/or in the insert in a production cycle of the containers, means for activating circulation being capable of controlling a start of said activation and a period of activation to promote the detachment of the wall from the bottom of the blown container and/or cooling the insert and/or the mold bottom.
